(19) United States
(12) Patent Application Publication
(10) Pub. No.: US 2006/0137802 A1
(43) Pub. Date: Jun. 29, 2006

(54) Green tire evolution for high speed uniformity

(76) Inventors: Julien Matthieu Flament, Clermont-Ferrand (FR); James Michael Traylor, Greer, SC (US)

Correspondence Address: Michelin North America, Inc.;Intellectual Property Department, P.O. Box 2026, Greenville, SC, 29602-2026, US

(21) Appl. No.: 11/320,370

(22) Filed: Dec. 28, 2005

Related U.S. Application Data
(63) Continuation-in-part of application No. 10/210,306, filed on Aug. 1, 2002.
(63) Continuation-in-part of application No. 11/172,060, filed on Jun. 30, 2005.

(51) Int. Cl. G01M 17/02; B29D 30/00

(52) U.S. Cl. 156/110.1; 73/146

(57) ABSTRACT

A method for controlling uniformity in tire manufacturing includes the steps of building at least one tire according to a series of process steps, determining summit mass imbalance of a tire, modeling green carcass radial runout as a sum of vectors representing contributions arising from the tire building steps, determining carcass force variation, determining a vectorial equation for the prediction of high speed uniformity based on at least the green tire radial runout and the summit mass imbalance of the tire, modifying the process to rotate the summit in relation to the carcass in order to optimize high speed uniformity per the said vectorial equation, and building at least one additional tire according to the modified series of process steps.

This application is a continuation-in-part of previously filed U.S. application Ser. No. 10/210,306 entitled Method for Controlling High Speed Uniformity in Tires and which was filed Aug. 1, 2002, and is a continuation-in-part of previously filed U.S. application Ser. No. 11/172,060 entitled Tire Manufacturing Method for Improving the Uniformity of a Tire which was filed Jun. 30, 2005.

### SUMMARY OF THE INVENTION

It is an object of the invention to provide a method for controlling the uniformity of tires in tire manufacture, comprising the steps of building at least one tire according to a series of process steps; determining summit mass imbalance of a tire; modeling green carcass radial runout as a sum of vectors representing contributions arising from the tire building steps; determining carcass force variation; determining a vectorial equation for the prediction of high speed uniformity based on at least the green tire radial runout and the summit mass imbalance of the tire; modifying the process to rotate the summit in relation to the carcass in order to optimize high speed uniformity per the said vectorial equation; and building at least one additional tire according to the modified series of process steps.

It is further an object of the invention to provide a method for controlling the uniformity of tires in tire manufacture, comprising the steps of building at least one tire according to a series of process steps; determining summit mass imbalance of a tire; modeling green carcass radial runout as a sum of vectors representing contributions arising from the tire building steps; determining carcass force variation; determining a vectorial equation for the prediction of high speed uniformity based on at least the green tire radial runout and the summit mass imbalance of the tire; modifying the process to rotate the summit in relation to the carcass in order to optimize high speed uniformity per the said vectorial equation; and modeling the effect of a curing process on the non-uniformity of the tire and then processing the optimal angle for the green tire in the curing press to minimize the non-uniformity of the cured tire.

### BRIEF DESCRIPTION OF THE DRAWINGS

FIG. 1 is a schematic view of a tire showing a frame of reference.

FIG. 2 is a vector polar plot showing the various contributors to green tire radial runout and the resulting radial runout.

FIG. 3 is a vector polar plot showing the various contributors to green tire radial runout and the resulting radial runout after optimization.

FIG. 4 is a vector polar plot showing the estimated summit radial runout vector as the difference between the green tire radial runout vector and the carcass radial runout vector.

FIG. 5 is a vector polar plot showing the two groupings of vector contributors as well as the resulting radial runout.

FIG. 6 is a vector polar plot showing the two groupings of vector contributors as well as the resulting radial runout after optimization.

FIG. 7 is a schematic of a tire showing the locations of various product joints and vector quantities for uniformity attributes and angular relations therebetween.

### DESCRIPTION OF PREFERRED EMBODIMENTS OF THE INVENTION

Tire uniformity relates to a tire's symmetry or asymmetry relative to its axis of rotation in terms of physical characteristics such as mass, geometry, and stiffness. Tire uniformity characteristics, or attributes, are generally categorized in terms of dimensional or geometric parameters (variations in radial run out, lateral run out, and conicity), mass (variance in mass imbalance about the axis), and rolling force (radial force variation, lateral force variation, and tangential force variation, sometimes also called longitudinal or fore and aft force variation). These values are typically reported as a vector, with the magnitude as the peak or maximum value and the direction given relative to the axis of rotation of the tire.

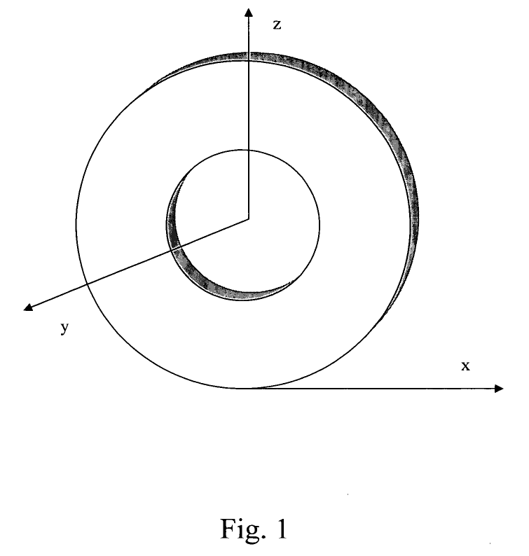

FIG. 1 shows a schematic view of a tire 10 showing a frame of reference for various uniformity attributes. The different rolling force variations are typically identified with a particular direction, for example, fore and aft, longitudinal, or tangential force variation along the x axis, lateral force variation along the y axis, and radial (or vertical) force variation along the z axis.

As known to those skilled in the art, there are various ways of measuring or calculating tire uniformity attributes. Direct measurement of high speed attributes tends to be time consuming and requires expensive test equipment. To overcome these difficulties, methods have been developed for using low speed attribute measurements to predict high speed attributes. An example of such a method is disclosed in U.S. Pat. No. 6,842,720 (Chang), which is commonly assigned with the instant application. This publication discloses a method for using Partial Least Square (PLS) regression techniques for relating low speed and geometric attributes to high speed attributes, and is incorporated herein by reference for all it discloses.

The inventors observed during tire testing that, within a set of identical tires (tires of the same model and size and made at the same time according to an identical process) differences in uniformity variance existed from tire to tire. In measuring the change in radial force variation from low speed (corresponding to about 10 kph) to high speed (corresponding to about 140 kph), the inventors noticed that while some tires showed an increase in radial force, others showed no increase or even a decrease. The inventors realized that by creating a method that identifies the factors responsible for these differences and controls for them, the high speed uniformity of tires could be improved.

The method of the invention provides for the modification of the tire building or manufacturing process to adjust selected uniformity attributes to reduce the measured variance in uniformity, and to thereby improve at least the tire's functional uniformity. The method initially models the green tire radial runout as a sum of vector contributors which can then be optimized to reduce non-uniformity. The tire high speed performance can then be predicted and optimized. The particular steps described below represent a preferred embodiment of the invention, and should not be read as limiting.

According to the invention, a method for controlling the uniformity of tires starts with the step of building at least one tire, or, alternatively, a set or tires, according to a series of defined process steps. As is known in the art, these process steps might include steps of laying plies or layers of different materials on a building drum, for example, the inner liner, carcass ply or plies, belts, sidewall covers, and tread. In addition, other products, such as the bead rings, bead reinforcement strips, and shoulder reinforcement strips, are positioned on the drum. The assembly is removed from the drum and is conformed to the toroidal tire shape. The conformed tire is placed in a mold, and heat and pressure are applied to form the shape features (tread pattern, sidewall markings, etc.) and to cure the rubber.

The invention can be used with any tire building process, and the description here of a particular process using a building drum is for illustrative purposes only. For example, the method of the invention could be used with a tire building process using a toroidal form on which the tire components are assembled in a tire-like shape and the conformation step is omitted.

Once the control set of tires is built, the next step is of measuring selected uniformity attributes for the tires. The attributes may include dimensional or geometric variations, mass variance, and rolling force variations. The dimensional attributes (such as radial runout), the values of which do not change substantially with rotation of the tire, may be measured using free spin or known static measuring devices. The following is a description of modeling the green tire radial runout of a tire in order to optimize its uniformity.

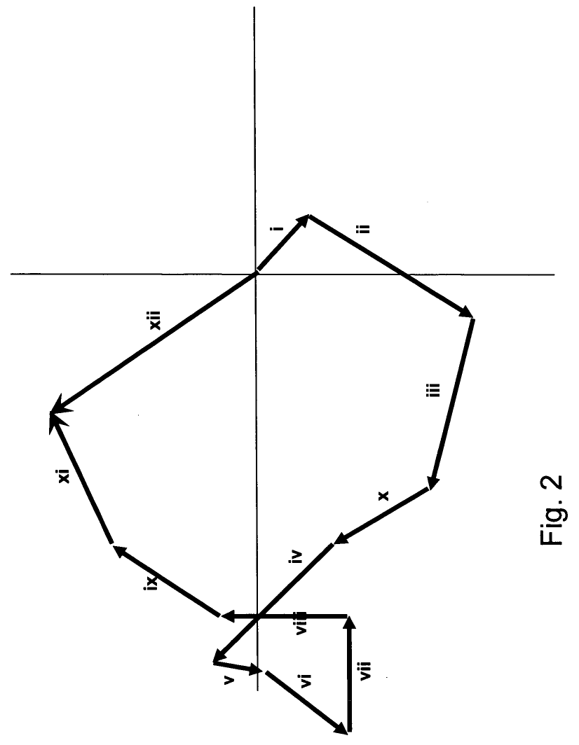

FIG. 2 shows the contributors to first harmonic of the green tire radial runout when no optimization has been applied. These include the various tooling vectors, product vectors, an intercept vector and the variable magnitude vectors. The tooling vectors are the 1^{st} (ii) and 2^{nd} (iii) stage building drum vectors, the summit building drum vector (iv) and the transfer ring vector (v). The building drums hold the the carcass and summit as the tire is being built, while the transfer ring holds the summit as it is being placed onto the tire carcass. The product vectors are the belt ply vectors (vi and vii), cap vector (viii) and tread vector (ix). The belt ply is the protective steel belt, the cap is a nylon cover that goes over the belt ply and the tread is interface between the tire and the ground. The green tire radial runout is the vector sum of the components. The remaining, unidentified factors are consolidated in the Intercept vector (i) I1. Throughout this disclosure, the Intercept vector I1 accounts for the unidentified effects. A unique attribute of the invention is the ability to optimize the after cure uniformity by manipulation of the tooling and product vectors. The ability to treat these effects in vector space is possible only when each harmonic has been extracted.

The measurement of green tire RRO (xii) is preferably at the completion of tire building and before the green tire is removed from the building drum. The Carcass gain vector (x) and Summit gain vector (xi) are also shown in FIGS. 2-4. In the preferred method, the measurement drum is the tire building drum, whether it is the single drum of a unistage machine or the finishing drum of a two-stage machine. The green tire RRO measurement may also be performed offline in a dedicated measurement apparatus. In either case, the radial runout of the measurement drum can introduce a false contribution to the Green RRO vector. When the green tire RRO is measured, the result is the sum of true tire runout and the runout of the drum used for measurement of RRO. However, only the green tire RRO has an affect on the after cure RFV of the tire.

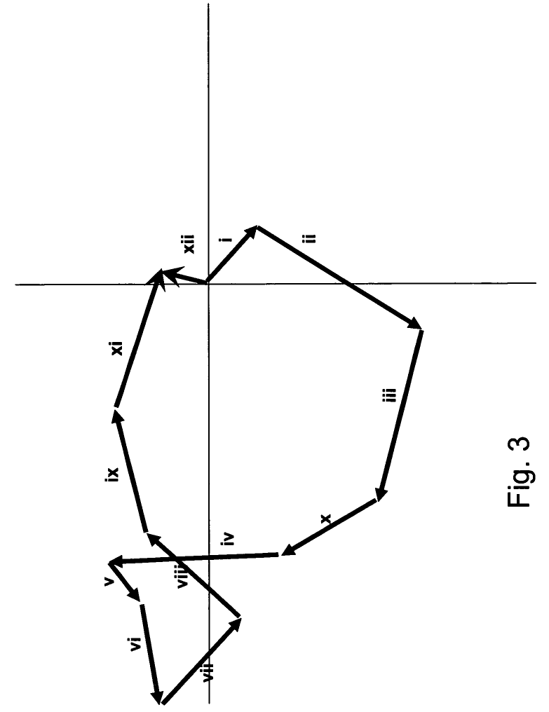

FIG. 3 now shows a schematic of the optimization step. In this view the vectors iv-ix have been rotated as a unit to oppose the variable vectors. It is readily apparent that this optimization greatly reduces the green tire radial runout. The steps for performing the optimization are provided below.

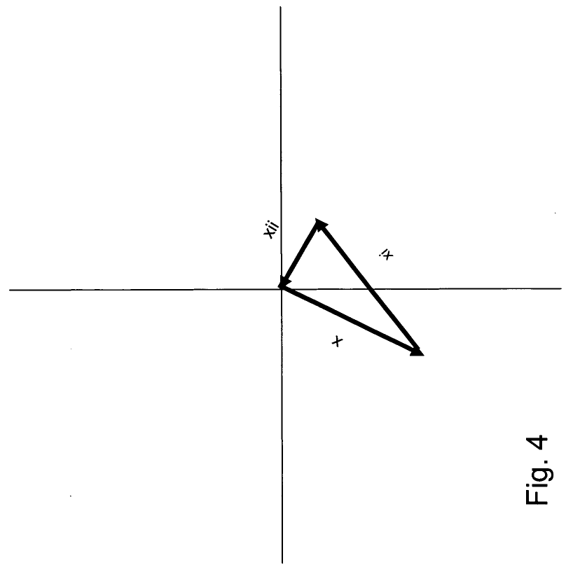

FIG. 4 is a vector plot showing the summit radial runout vector as the difference between the measured green tire radial runout vector and the measured carcass radial runout vector. This computation can be used as equivalent to a direct measurement of the summit radial runout vector and obviates the need for taking the measurements for the summit.

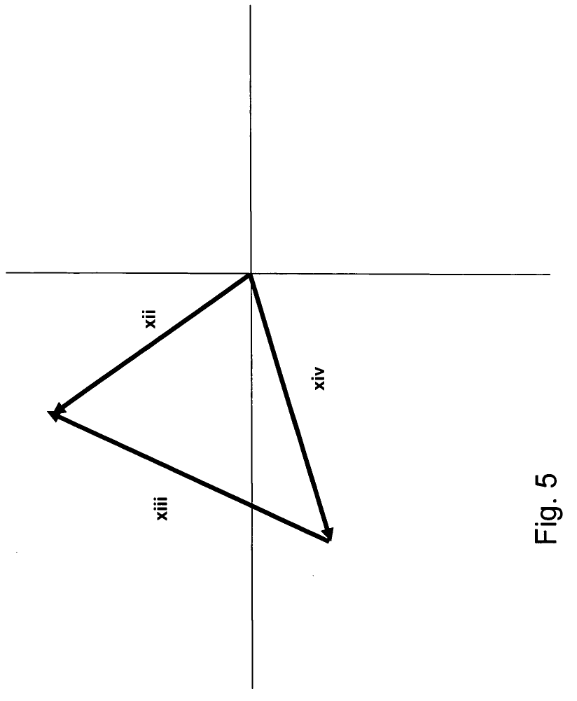

FIG. 5 is a vector polar plot showing the grouping of contributors to the first harmonic of the green tire radial runout when no optimization has been applied. Reference number 13 is the resultant vector sum of constant vectors iv through ix and variable vector xi. Reference number 14 is the resultant vector sum of constant vectors i through iii and variable vector xi. Reference number xii is the same green tire radial runout as shown in FIG. 2.

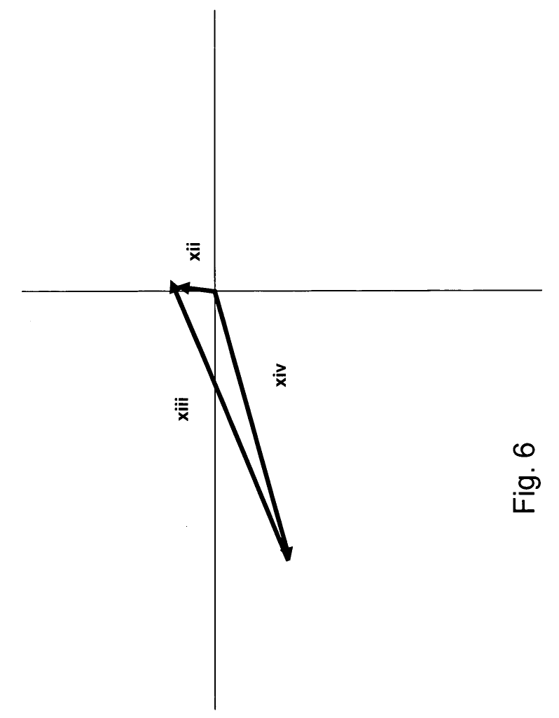

FIG. 6 is a vector polar plot showing the grouping of contributors to the first harmonic of the green tire radial runout after optimization has been applied. Reference number 13 is the resultant vector sum of constant vectors iv through ix and variable vector xi. Reference number 14 is the resultant vector sum of constant vectors i through iii and variable vector xi. Reference number xii is the same optimized green tire radial runout as shown in FIG. 3.

The foregoing graphical representations in vector space can now be recast as equation (1) below where each term represents the vectors shown in the example of FIG. 2. The method can be applied to additional effects not depicted in FIG. 2 nor described explicitly herein without departing from the scope of the invention.

$$FRH 1 = ( FRH 1 crEffect vector ) + ( FRH 1 sr Effect vector ) + ( {1}^{st} Stage Building Drum RRO vector ) + ( {2}^{nd} Stage Building Drum RRO vector ) + ( Summit Building Drum RRO vector ) + ( Transfer Ring RRO vector ) + ( Belt 1 Ply RRO vector ) + ( Belt 2 Ply RRO vector ) + ( Cap RRO vector ) + ( Tread RRO vector ) \qquad ( 1 )$$

The preceding equation applies to modeling the 1^{st} harmonic of radial runout, but holds for other harmonics such as FRH2-FRH5 as well. The first step in implementation of the method is to gather data to build the modeling equation. The Green RRO and Effect vectors are measured quantities. The challenge is to estimate the gain vectors, the product vectors, the tooling vectors and the intercept vector. This is accomplished by vector rotation and regression analysis.

First, a reference point on the tire, such as a barcode applied to the carcass or a product joint that will be accessible through the entire process is identified. In the specific example described herein, the invention contains an improvement to account for the radial runout of the measurement drum itself. The loading angle of the tire carcass on the measurement drum is recorded. For this specific example, the loading angle is measured as the carcass is loaded on either the first stage of a unistage or a second stage of a two-stage machine. It is advantageous to ensure a wide variation of the loading angle within a given sample of tires to ensure accurate estimation of the effect of the measurement drum runout on the vector coefficients.

Next, the RRO of the finished, green tire is measured by a measurement device while the tire is mounted on the finishing stage building drum and rotated. Alternatively, the finished, green tire may be moved to separate measurement apparatus and the RRO measurement made there. This RRO measurement is repeated for multiple tires to randomize the effects that are not modeled. There are many known devices to obtain the RRO measurement such as a non-contact system using a vision system or a laser. The RRO data thus acquired is recorded in a computer.

Once the data has been acquired for a suitable sample of tires, the harmonic data are extracted from the RRO waveforms. In the present invention the first harmonic data of the green radial runout GR1 (magnitude FRM1 and azimuth FRA1), carcass runout (magnitude FRM1cr and azimuth FRA1cr) and summit runout (magnitude FRM1sr and azimuth FRA1sr) respectively are extracted and stored. The following table indicates the specific terminology.

| Vector | Magnitude | Azimuth |
|---|---|---|
| Green RRO (GR1) | FRM1 | FRA1 |
| Carcass Gain (gn) | Gcr | θ |
| Summit Gain (gn) | Gsr | θ |
| Intercept (I1) | IM1 | IA1 |
| 1^{st} Stage Building Drum | BM1r | BA1r |
| 2^{nd} Stage Building Drum | TM1r | TA1r |
| Transfer Ring | RM1r | RA1r |
| Summit Building Drum | SM1r | SA1r |
| Belt Ply | NM1r | NA1r |
| Cap | BZM1r | BZA1r |
| Tread | KM1r | KA1r |

To facilitate rapid application of equation (1) in a manufacturing environment, it is advantageous to use a digital computer to solve the equation. This requires converting the vector equations above to a set of arithmetic equations in Cartesian coordinates. In Cartesian coordinates, each vector has an x-component and a y-component. Simplifying yields:
FRH1rₓ=a·FRM1crx−b·FRM1cry+c·FRM1srx−d·FRM1sry+e·CBD_{—}REFx−f·CBD_{—}REFy+g·FBD_{—}REFx−h·FBD_{—}REFy+i·SBD_{—}REFx−j·SBD_{—}REFy+k·TSR_{—}REFx−l·TSR_{—}REFy+m·NBD_{—}REFx−n·NBD_{—}REFy+o·BBD_{—}REFx−p·BBD_{—}REFy+q·KBD_{—}REFx−r·KBD_{—}REFy+Ix (2)
FRH1r_{y}=a·FRM1cry−b·FRM1crx+c·FRM1sry−d·FRM1srx+e·CBD_{—}REFy−f·CBD_{—}REFx+g·FBD_{—}REFy−h·FBD_{—}REFx+i·SBD_{—}REFy−j·SBD_{—}REFx+k·TSR_{—}REFy−l·TSR_{—}REFx+m·NBD_{—}REFy−n·NBD_{—}REFx+o·BBD_{—}REFy−p·BBD_{—}REFx+q·KBD_{—}REFy−r·KBD_{—}REFx+Iy (3)
based upon the following identities:
a=Gcr·COS(Θ), b=Gcr·SIN(Θ) (4)
c=Gsr·COS(θ), d=Gsr·SIN(θ) (5)
e=BM1r·COS(BA1r), f=BM1r·SIN(BA1r) (6)
g=TM1r·COS(TA1r), h=TM1r·SIN(TA1r) (7)
i=SM1r·COS(SA1r), j=SM1r·SIN(SA1r) (8)
k=RM1r·COS(RA1r), l=RM1r·SIN(RA1r) (9)
m=NM1r·COS(NA1r), n=NM1r·SIN(nA1r) (10)
o=BZM1r·COS(BZA1r), p=BZM1r·SIN(BZA1r) (11)
q=KM1r·COS(KA1r), r=KM1r·SIN(KA1r) (12)

The equations (2) and (3) immediately above can be written in matrix format. When the predictive coefficients vectors (a,b), (c,d), (e,f), (g,h), (i,j), (k,l), (m,n), (o,p), (q,r), and (I1_{X},I1_{Y}) are known, the matrix equation provides a modeling equation by which the VRH1 vector for an individual tire may be estimated. This basic formulation can also be modified to include other process elements and to account for different production organization schemes. These coefficient vectors may be obtained by various known mathematical methods to solve the matrix equation above.

In a manufacturing environment and to facilitate real-time use and updating of the coefficients, the method is more easily implemented if the coefficients are determined simultaneously by a least-squares regression estimate. All coefficients for all building drums and products may be solved for in a single regression step. Finally the vector coefficients are stored in a database for future use. The coefficients have a physical significance as follows: (a,b) is the carcass gain vector in units of mm of GTFR, (c,d) is the summit gain vector in units of mm of GTFR, (e,f) is the first stage building drum vector in units of mm of GTFR, (g,h) is the second stage building drum vector in units of mm of GTFR, (i,j) is the summit building drum vector in units of mm of GTFR, (k,l) is the transfer ring vector in units of mm of GTFR, (m,n) is the belt ply vector in units of mm of GTFR, (o,p) is the cap vector in units of mm of GTFR, (q,r) is the tread vector in units of mm of GTFR and (I_{X}, I_{Y}) is the Intercept vector I1 in units of mm of GTFR.

The equations listed above are for one first stage building drum, one second stage building drum, one summit building drum, etc. The products and tooling factors are nested factors meaning that although the actual process contains many building drums and many products, each tire will see only one of each. Thus the complete equation may include a vector for each building drum and each product.

The final step is to apply the model to optimize the RRO of individual tires as they are manufactured according to the illustration shown in FIG. 3. When subsequent tires are manufactured, the constant vectors are rotated to minimize the green tire RRO. The rotations will be calculated such that when combined with the variable effects coefficients (a,b) and (c,d), it is possible to minimize the estimated vector sum of all the effects. In FIGS. 2 and 3, it is shown that the vectors iv-ix are rotated as a group leading to a considerably smaller resulting green RRO. At this point in the process the summit has been built and is in the transfer ring awaiting positioning on the carcass. Mathematically this means that the constant vectors iv, v, vi, vii, viii and ix and the variable vector xi in FIG. 3 are combined into one resultant vector. This is shown as reference number xiii in FIGS. 5 and 6. The carcass has also been built and is sitting inflated on the 2nd stage building drum. Mathematically this means that the constant vectors i, ii and iii and the variable vector x are combined into a second resultant. This is shown as reference number xiv in FIGS. 5 and 6. We then rotate the first resultant opposite the second resultant. The rotation is achieved by rotating the 2nd stage building drum under the transfer ring in effect positioning the resultant of iv, v, vi, vii, viii, ix and xi opposite the resultant of i, ii, iii and x. Each tire building drum carriers an identification and each tire carries a unique identification device, such as a barcode. These identification tags allow the information recorded for an individual tire to be retrieved and combined at a later step. At the completion of tire building, the green RRO is measured and its harmonic magnitude FRM1 and azimuth FRA1 are recorded along with the loading angle of the tire on the building or measurement drum. A reading device scans the unique barcode to identify the tire, to facilitate polling the database to find the measured and recorded tire information: FRM1 and FRA1, the building drum identification, and the loading angle. Because the variable effects are changing from tire to tire, the rotation of the fixed vectors will change from tire to tire.

The force-related attributes, which manifest themselves when the tire is rotating and are typically speed sensitive, are measured at high speed (typically 140 kph) and at low speed (typically 8-10 kph). Those skilled in the art will understand that force-related, or dynamic, attributes will also consist of a set of values corresponding to a series of harmonics, that is, measurement values related to the frequency of appearance of the attribute during a rotation of the tire. Generally, the first harmonics (those occurring once per rotation) produce the largest magnitude forces, and are, accordingly, of the greatest interest for tire ride comfort. The method in accordance with the invention is also applicable to higher harmonics.

A uniformity attribute of interest is selected as or determined to be the target attribute. The target attribute may be of interest because of a particular requirement of an automobile manufacturer. Alternatively, the attribute may be determined to be the target because it has a high magnitude, which may be the result in a change in the tire manufacturing process or a change in materials.

The selected attributes are determined as vector quantities having a magnitude and a direction relative to the tire geometry. As pointed out above in regard to radial runout, a particular vector quantity represents the sum of the contributions to that attribute by different products or processes, which will be referred to as the input attributes. Mass variance for the tire will have contributions from the mass variance for each of the products and will represent the sum of those individual contributions. In addition, a particular product or process may contribute to more than one attribute. The tread, for example, may contribute to mass variance and may also contribute to the radial force variation.

As will be understood by those of skill in the art, analyzing all possible attribute variances would be unwieldy. Accordingly, a method such as that disclosed in Chang, is used to relate the target attribute to other measured uniformity attributes. By relating the target attribute to the input attributes, the target attribute is defined in terms of a limited number of attributes that have the strongest influence on the target attribute, and may be easier to measure and/or easier to control through process change.

A relation of the target attribute to input attributes may be expressed as:
HV1=A*LV1+B*X+C+U (13)
where, HV1 is the high speed target attribute, LV1 is the low speed input attribute, X is a second input attribute, A and B are coefficients, C is a constant, and U represents all other inputs. Of course, additional input attributes may be included, but, for simplicity of the explanation, three inputs (LV, X, U) are used.

The attributes are vectors, and, thus, Equation 13 can be rewritten to express the vector quantities as the x and y components:
HV1ₓ=A_{1,1}*LV1ₓ+A_{1,2}*LV1_{y}+B_{1,1}*Xₓ+B_{1,2}*X_{y}+C1+U1 (14)
HV1_{y}=A_{2,1}*LV1ₓ+A_{2,2}*LV1_{y}+B_{2,1}*Xₓ+B_{2,2}*X_{y}+C2+U2 (15)

Next, using Principle Components Analysis (PCA) techniques, the relative importance of each of the input attributes to the target attribute is determined. A numerical value representing the importance of each input attribute is obtained from the PCA. Also, the input attributes are tested in groups to determine the amount of contribution to the target attribute. The result is groupings of input variables with an associated percentage value indicating what percentage of the target attribute is explained by each group.

From the determinations of the importance and the contribution, the overall contribution of a particular input attribute to the target attribute could be judged to be small and this attribute could be eliminated from further consideration without introducing significant error. Accordingly, the most significant input attributes are then selected for use in subsequent steps of the method of the invention, which simplifies the handling of the attributes.

The Partial Least Squares regression will determine the coefficients A_{1,2}, A_{1,2}, A_{2,1}, A_{2,2}, B_{1,1}, B_{1,2}, B_{2,1}, B_{2,2}, C₁, and C₂ for equations 14 and 15. The magnitude of the coefficients suggest how much the associated attribute changes with speed. The coefficients for attribute magnitude values that are at or close to unity suggest, for example, that the associated attribute does not change appreciably with speed. The coefficients for attribute direction or angle values that are at or near zero suggest little or no change to vector direction.

Assuming for the purposes of this description that the unknown factor U can be ignored, equations 4 and 5 may be rewritten as:
HV1ₓ=A_{1,1}*LV1ₓ+A_{1,2}*LV1_{y}+B_{1,1}*Xₓ+B_{1,2}*X_{y}+C1+U1 (16)
HV1_{y}=A_{2,1}*LV1ₓ+A_{2,2}*LV1_{y}+B_{2,1}*Xₓ+B_{2,2}*X_{y}+C2+U2 (17)
In fact, as demonstrated by Principle Components Analysis, the contribution of U to HV is less than 5%.

The goal of reducing the magnitude of the high speed radial force variation can be addressed through control of the input attributes. One available avenue is in the direction of the input attribute vectors. Because the input attributes are vector quantities, both the magnitude and direction of the input attributes contributes to the target attribute. It is possible, therefore, to arrange vector directions so that the resultant target attribute is minimized.

As mentioned above, each of the products assembled in the tire contributes to the uniformity attributes and many products are assembled on the building drum or form in a manner that requires a seam or joint. Rearrangement of the various joints could be done to modify the mass distribution of the tire, and thus, redirect the vectors for the input attributes so that the resultant target is minimized. The effect of a change on the relative position of each product cannot be measured directly, however, and must be calculated through iterative testing. One way is by building in series tires or sets of tires, each having one or more changed attributes, measuring the attributes, and observing the differences among them. For example, in each set after the first one, the joints of summit products are set at a specified angle relative to the previous group. By measuring the mass imbalance of all the groups, the summit mass imbalance can be determined. The number of groups is defined as n+1, where n is the harmonic number interested in. If prior knowledge about distribution of mass imbalance is available, the number of groups needed from summit mass imbalance can be reduced to n. The regression described above allows, if desired, the use of easier to measure low speed attributes, which can be related to the high speed target. As an alternative to the above approach, the summit mass imbalance can be estimated based on the summit mass density. Given the fact that rubber is incompressible, the mass imbalance will be directly proportional to the summit thickness measurement.

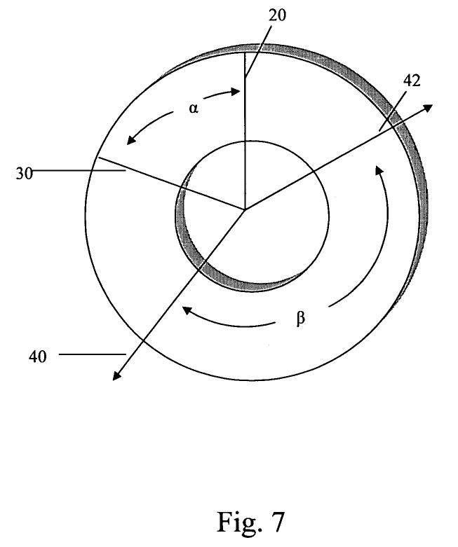

FIG. 7 is a schematic representation of a tire showing the relative position of various products and product joints. The inner liner joint 20 is convenient to use as a reference joint because it is the first product positioned on the building drum or form for tubeless, pneumatic tires. Other product joints, such as the tread joint 30, the belt joints and the casing joint (not illustrated) or other products, can be referenced to the inner liner joint 20. A reference rotation angle α between the inner liner joint 20 and the tread layer joint 30 is shown. The building process can track the various joint locations through known indexing methods. Also shown on FIG. 5 are vectors representing a first input attribute 40 and a second input attribute 42, with a relative phase angle β indicated.

Thus, for example, if the analysis indicated that the phase angle between the first attribute 40 and second attribute 42 should be 180 degrees to minimize the target attribute, a second set of tires could be manufactured with the relative location of the tread joint 30 and carcass joint 20 changed. The second set of tires would be tested for the effect of moving the joints on the relative location of the first and second input attributes. The direction and magnitude of the vectors for the first 40 and second 42 attributes is then measured, the phase angle determined, and the effect on the target attribute is also determined. Such a procedure could be repeated as necessary to obtain the desired phase angle. During repeated builds, the desired phase angle may be refined as determined by the results of the builds and tests.

In future tires, the orientation of other joints or products could be changed, and those effects measured. This would continue until sufficient information was gained to specify the placement of the various products to achieve the desired phase angle between the input attributes. Thus, a non-uniformity related to the tread (the tread joint) can be used to counter a non-uniformity related to the carcass or belts, for example, to minimize the overall non-uniformities present in the tire.

Further, tire process steps other than the location of a product or product joint could be addressed in making changes for measurement and comparison. For example, the relative orientation of the tire in the mold press could be changed to measure its effect. Alternatively, control of the tolerance for placing certain products on the drum or form could be analyzed, for example, the cord spacing in the carcass or belts, the product thickness, the tension at which a product is applied, and other factors known to the art.

It will be understood by those skilled in the art that obtaining perfect orientation of the product joints through the above process is unlikely. The process seeks, rather, to approach the phase angle, and it is believed that a range of +−30 degrees will obtain significant improvement, and +−15 degrees being more preferred.

Another available avenue for changing a vector is to reduce the magnitude of the vector. In the case of mass imbalance, which the inventors have found to have a significant contribution to high speed uniformity, the mass imbalance vector may be modified altering the mass distribution of the tire by adding or removing material from the tire crown area at a location opposite the mass imbalance vector. This could be done with an uncured or cured tire.

1. A method for controlling the uniformity of tires in tire manufacture, comprising the steps of:
building at least one tire according to a series of process steps;
determining summit mass imbalance of a tire;
modeling green carcass radial runout as a sum of vectors representing contributions arising from the tire building steps;
determining carcass force variation;
determining a vectorial equation for the prediction of high speed uniformity based on at least the green tire radial runout and the summit mass imbalance of the tire;
modifying the process to rotate the summit in relation to the carcass in order to optimize high speed uniformity per the said vectorial equation; and
building at least one additional tire according to the modified series of process steps.

2. The method according to claim 1, wherein the said summit mass imbalance is modeled from a thickness variation measurement of the summit.

3. The method according to claim 2, wherein the said carcass force variation is modeled from a measurement of the green carcass radial runout.

4. The method according to claim 2, wherein the summit thickness variation is calculated as the difference between the tire's total measured radial runout and the tire's carcass radial runout plus fixed vector of the transfer ring.

5. The method according to claim 1 which comprises building at least one subsequent tire with a product joint rotated in relation to a reference joint, measuring the tire vector quantities, and calculating the summit mass imbalance from the differences in the at least two tires' vector quantities.

6. The method according to claim 1 which comprises performing for at least one harmonic an estimation of an optimized angle between carcasse and summit in order to minimize radial runout;

7. A method for controlling the uniformity of tires in tire manufacture, comprising the steps of:
building at least one tire according to a series of process steps;
determining summit mass imbalance of a tire;
modeling the green tire radial runout of a tire in the manufacturing process as a vector sum of each of the vectors representing contributions arising from the tire building steps;
determining a vectorial equation for the prediction of high speed uniformity based on at least the green tire radial runout and the summit mass imbalance of the tire;
modifying the process to rotate the summit in relation to the carcass in order to optimize high speed uniformity per the said vectorial equation; and
modeling the effect of a curing process on the non-unformity of the tire and then processing the optimal angle for the green tire in the curing press to minimize the non-uniformity of the cured tire.

8. The method according to claim 6, wherein modeling the effect of the curing process on the non-unformity of the tire comprises putting out-of-phase the green tire radial runout and the radial force signature of the curing step.

9. The method according to claim 6, wherein modeling the effect of the curing process on the non-unformity of the tire comprises putting out-of-phase the green carcasse radial runout and the radial force signature of the curing step.

10. The method according to claim 6, wherein modeling the effect of the curing process on the non-unformity of the tire comprises putting out-of-phase the summit mass imbalance and the mass imbalance signature of the curing step.

11. The method according to claim 6, wherein modeling the effect of the curing process on the non-unformity of the tire comprises putting out-of-phase the summit mass imbalance and the radial force signature of the curing step.

12. The method according to claim 6, wherein modeling the effect of the curing process on the non-unformity of the tire comprises putting out-of-phase the radial force signature of the curing step with the vectorial sum of green carcasse radial runout and summit thickness variation.

13. The method according to claim 6, wherein modeling the effect of the curing process on the non-unformity of the tire comprises putting out-of-phase the vectorial sum of summit mass imbalance and the mass imbalance signature of the curing step and vectorial sum of green carcasse radial runout and the radial force signature of the curing step.
